(19) United States
(12) Patent Application Publication
(10) Pub. No.: US 2017/0142245 A1
(43) Pub. Date: May 18, 2017

(54) ELECTRONIC APPARATUS WITH SHAREABLE INPUT DEVICES AND INPUT DEVICE SHARING METHOD THEREOF

(71) Applicants: INVENTEC (PUDONG) TECHNOLOGY CORPORATION, Shanghai City (CN); INVENTEC CORPORATION, Taipei City (TW)

(72) Inventors: Tsan-Yun LIN, Taipei City (TW); Cheng-Pin CHEN, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/235,039

(22) Filed: Aug. 11, 2016

(30) Foreign Application Priority Data
Nov. 18, 2015 (CN) 201510794915.9

(51) Int. Cl. H04M 1/725

(52) U.S. Cl. CPC H04M 1/72527

(57) ABSTRACT

An electronic apparatus and a sharing method thereof are provided. The electronic apparatus includes an input device, a control module, a signal processing module and a connection module and is selectively electrically connected to an external electronic apparatus. The input device produces a control signal according to input information. The control module determines whether to share the input device with the external electronic apparatus and according to the determination result, outputs the control signal either to the signal processing module through a first signal transmission path or to the connection module through a second signal transmission path. When receiving the control signal through the first signal transmission path, the signal processing module executes an input operation. When receiving the control signal through the second signal transmission path, the connection module outputs the control signal to the external electronic apparatus.

### CROSS-REFERENCE TO RELATED APPLICATIONS

This non-provisional application claims priority under 35 U.S.C. §119(a) on Patent Application No(s). 2015107949159 filed in China on Nov. 18, 2015, the entire contents of which are hereby incorporated by reference.

### BACKGROUND

Technical Field

The disclosure relates to an electronic apparatus with sharable input devices and an input device sharing method thereof, more particularly to an electronic apparatus capable of sharing its input device with an external electronic apparatus, and a sharing method thereof.

Related Art

The development of mobile electronic devices has caused the popularization of notebooks and smart phones. Users can use their notebooks or smart phones to do some works any time any where without the limitation in where such electronic apparatuses are used. Moreover, modern apps installed in smart phones allow people to use their smart phone to do many things, such as sending messages, sending emails, satellite positioning, navigation, holding a teleconference or other things.

In general, a notebook has its keyboard, touch panel or an external mouse for users to input information. As compared to notebooks, smart phones are relatively small, light and thin so that smart phones are convenient to carry on or hold a phone call. However, the input devices of smart phones are also minimized, and thus, it is inconvenient and has errors easily to key information into or operate the keyboard or screen of the smart phone.

### SUMMARY

The disclosure provides an electronic apparatus with a sharable input device and an input device sharing method thereof to share a keyboard, a touch panel or another add-in input device of a notebook with a smart phone in order to diminish inconveniences in the compilation of documents and the input of information on a smart phone.

In one or more embodiments, the input device sharing method is applied to a first electronic apparatus that is selectively and electrically connected to a second electronic apparatus. The input device sharing method includes: at least one input device of the first electronic apparatus generating a control signal according to input information; according to an assignment signal, determining whether to share the at least one input device with the second electronic apparatus; and selectively outputting the control signal through either a first transmission path or a second transmission path according to the determination result. When a signal processing module of the first electronic apparatus receives the control signal through the first transmission path, the signal processing module performs an input operation according to the control signal; and the second electronic apparatus receives the control signal through the second transmission path.

In one or more embodiments, the electronic apparatus includes at least one input device, a control module, a signal processing module and a connection module. The input device generates a control signal according to input information. The control module is electrically connected to the at least one input device, determine whether to share the at least one input device with an external electronic apparatus according to an assignment signal, and selectively outputs the control signal through either a first transmission path or a second transmission path according to the determination result. The signal processing module is electrically connected to the control module through the first transmission path and performs an input operation according to the control signal when receiving the control signal through the first transmission path. The connection module is electrically connected to the control module through the second transmission path and selectively electrically connected to the external electronic apparatus. The connection module transmits the control signal to the external electronic apparatus when receiving the control signal through the second transmission path.

In view of the aforementioned electronic apparatus and input device sharing method, the control module in the electronic apparatus determines whether to share a shareable input device with an external electronic apparatus, so as to selectively output the control signal through either the first transmission path or the second transmission path. Therefore, the smart phone can use the keyboard, touch panel or another add-in input device of the notebook, thereby diminishing inconveniences in the compilation of documents and the input of information on a smart phone.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a first electronic apparatus and a second electronic apparatus in an embodiment;

FIG. 2 is a flow chart of an input device sharing method in an embodiment;

FIG. 3 is a flow chart of an input device sharing method in another embodiment;

FIG. 4 is a functional block diagram of a first electronic apparatus and a second electronic apparatus in another embodiment; and

FIG. 5 is a schematic diagram of a first transmission path and a second transmission path in an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

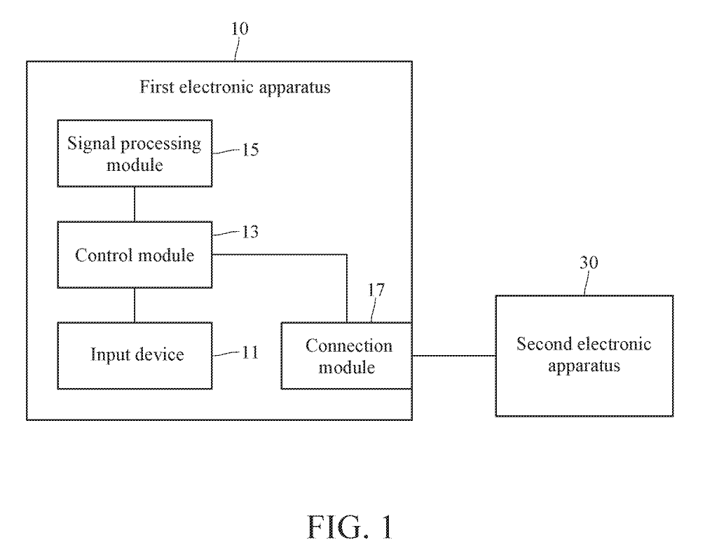

Please refer to FIG. 1. FIG. 1 is a functional block diagram of a first electronic apparatus and a second electronic apparatus in an embodiment. A first electronic apparatus 10 includes an input device 11, a control module 13, a signal processing module 15 and a connection module 17. The first electronic apparatus 10 is selectively and electrically connected to a second electronic apparatus 30. Instances of the first electronic apparatus 10 include a notebook, a desk-top computer or other possible electronic apparatus. The input device is built in the first electronic apparatus 10 in an embodiment and is externally connected to the first electronic apparatus 10 in another embodiment.

The input device 11 generates a control signal according to input information. For example, the input device 11 is a keyboard, a computer mouse, a touch panel or other device by which users can input information. The input information herein is related to actions executed on the input device 11. For example, when a user keys the input information on a keyboard of a notebook, this keyboard will generate a control signal according to the input of the user or the keys pressed by the user.

The control module 13 is electrically connected to the input device 11. The control module 13, according to an assignment signal, determines whether to share the at least one input device 11 with the second electronic apparatus 30. Then, the control module 13, according to the determination result, selectively outputs the control signal either to the signal processing module 15 through a first transmission path or to the connection module 17 through a second transmission path. The control module 13 is, for example, but not limited to, an embedded controller (EC) in a notebook so the control module 13 can receive the control signal generated by the keyboard, and can send the control signal to either the signal processing module 15 or the connection module 17 in the notebook.

The signal processing module 15 is electrically connected to the control module 13 through the first transmission path so when the signal processing module 15 receives the control signal through the first transmission path, the signal processing module 15, according to the control signal, executes a first input operation. The signal processing module 15 is, for example, but not limited to, a platform controller hub (PCH) of a notebook so when the signal processing module 15 in the notebook receives the control signal from the keyboard, the signal processing module 15 will deliver the control signal to either a south bridge chip or a north bridge chip of the notebook to command either the south bridge chip or the north bridge chip to do a relative action.

The connection module 17 is electrically connected to the control module 13 through the second transmission path, and the connection module 17 is electrically connected to the second electronic apparatus 30 selectively. When the connection module 17 receives the control signal through the second transmission path, the connection module 17 will send the control signal to the second electronic apparatus 30. The connection module 17 is, for example, but not limited to, a universal serial bus (USB), a serial advanced technology attachment (SATA) connecting interface or any suitable connecting interface. The second electronic apparatus 30 is electrically connected to the connection module 17 in the first electronic apparatus 10 through a commensurate transmission line.

In an embodiment, the assignment signal is generated by a selecting module on the first electronic apparatus 10. The selecting module is, for example, but not limited to, a key or switch disposed on the outer surface of the first electronic apparatus 10 so the user can use a key on the outer surface of the first electronic apparatus 10 to assign the usage right of the input device 11 in the first electronic apparatus 10 to either the first electronic apparatus 10 or the second electronic apparatus 30. If the user by the selecting module in the first electronic apparatus 10 decides to share the input device 11 in the first electronic apparatus 10 with the second electronic apparatus 30, the selecting module will generate an assignment signal in response to the selection result, the control module 13 will, according to the assignment signal, send the control signal generated by the input device 11 to the connection module 17 through the second transmission path, and the connection module 17 will transfer this control signal to the second electronic apparatus 30. Herein, the second electronic apparatus 30 can execute a relative input operation according to the control signal. If the user does not by the selecting module in the first electronic apparatus 10 decides to share the input device 11 in the first electronic apparatus 10 with the second electronic apparatus 30, no matter if the second electronic apparatus 30 is electrically connected to the selecting module, the control module 13 will generate the assignment signal in response to the selecting module to send the control signal generated by the input device 11 to the signal processing module 15 through the first transmission path. Herein, the signal processing module 15 executes the relative input operation according to this control signal.

In another embodiment, the assignment signal is generated by the second electronic apparatus 30. For example, when the second electronic apparatus 30 is electrically connected to the first electronic apparatus 10, the second electronic apparatus 30 will send a signal to the first electronic apparatus 10 so the first electronic apparatus 10 can know that it has contact with the first electronic apparatus 10. The signal sent out by the second electronic apparatus 30 is considered an assignment signal. When the control module 13 in the first electronic apparatus 10 receives the assignment signal generated by the second electronic apparatus 30, the control module 13 in the first electronic apparatus 10 will learn that the input device 11 should be shared with the second electronic apparatus 30, and will send the control signal to the second electronic apparatus 30 through the second transmission path.

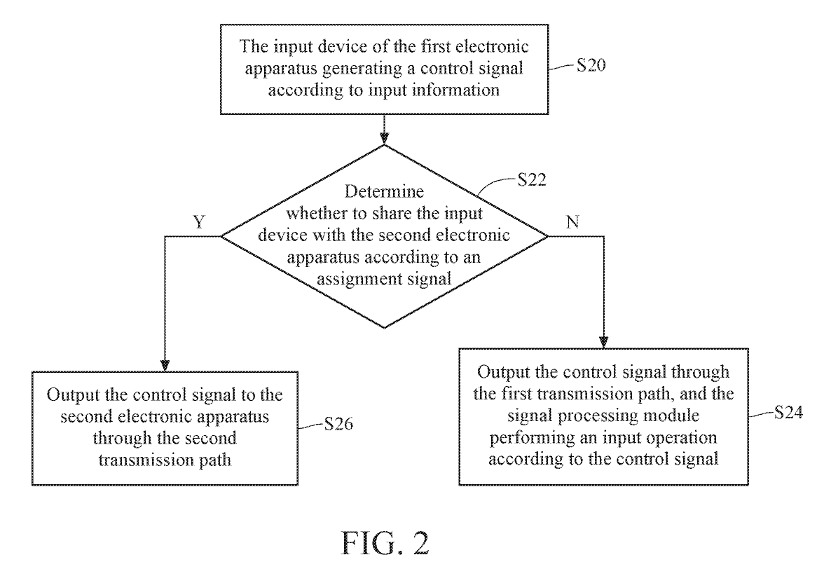

An input device sharing method promoted in the disclosure is clarified as follows with respect to the functional block diagram of the above first electronic apparatus 10. Please refer to FIG. 1 and FIG. 2. FIG. 2 is a flow chart of an input device sharing method in an embodiment. The input device sharing method includes the following steps. In step S20, the input device 11 of the first electronic apparatus 10 generates a control signal according to input information. In step S22, the first electronic apparatus 10, according to an assignment signal, determines whether to share the input device 11 with the second electronic apparatus 30. In step S24, when the first electronic apparatus 10 determines not to share the input device 11 with the second electronic apparatus 30 in response to the assignment signal, the first electronic apparatus 10 will output the control signal through the first transmission path so the signal processing module 15 in the first electronic apparatus 10 can execute an input operation according to the control signal. In step S26, when the first electronic apparatus 10 determines to share the input device 11 with the second electronic apparatus 30 according to the assignment signal, the first electronic apparatus 10 will output the control signal to the second electronic apparatus 30 through the second transmission path.

In an exemplary embodiment, assume that the first electronic apparatus 10 is a notebook and the second electronic apparatus 30 is a smart phone. When this smart phone is electrically connected to this notebook, the control module 13 in this notebook, according to an assignment signal, determines whether to share a keyboard of the notebook with this smart phone. For instance, the assignment signal herein is generated by a pressed key on the notebook or is generated when this smart phone connects to this notebook. After the control module 13 in the notebook determines to share the keyboard with the smart phone, what the user keys on the keyboard will be shown on the smart phone. That is, the smart phone receives the control signal generated by the keyboard from the connection module 17 in the notebook and executes an input operation, e.g. displaying what the user has keyed in, corresponding to the control signal.

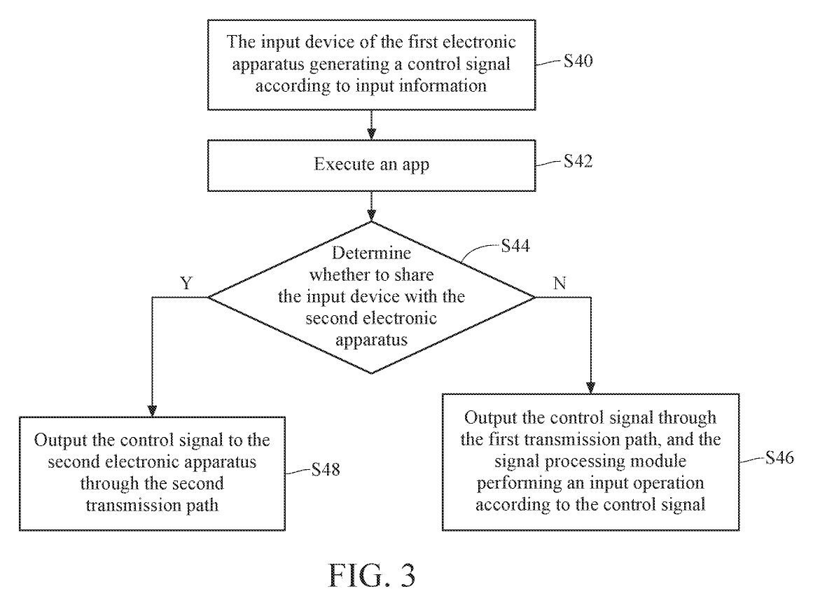

Please refer to FIG. 1 and FIG. 3. FIG. 3 is a flow chart of an input device sharing method in another embodiment. The input device sharing method includes the following steps. In step S40, the input device 11 of the first electronic apparatus 10 generates a control signal according to input information. In step S42, the first electronic apparatus 10 executes an app. In step S44, the executed app determines whether the second electronic apparatus 30 proposes a request for sharing the input device 11. In step S45, when the executed app determines that the second electronic apparatus 30 proposes the request, the control module 13 will output the control signal through the first transmission path and the signal processing module 15 in the first electronic apparatus 10 will execute an input operation according to the control signal. In step S46, when the executed app determines that the second electronic apparatus 30 does not propose the request, the control module 13 will output the control signal to the second electronic apparatus 30 through the second transmission path. In other words, in this embodiment, the first electronic apparatus 10 employs an executed app to determine whether the second electronic apparatus 30 proposes a request for sharing the input device 11, and the executed app will generate the assignment signal when the second electronic apparatus 30 proposes the request.

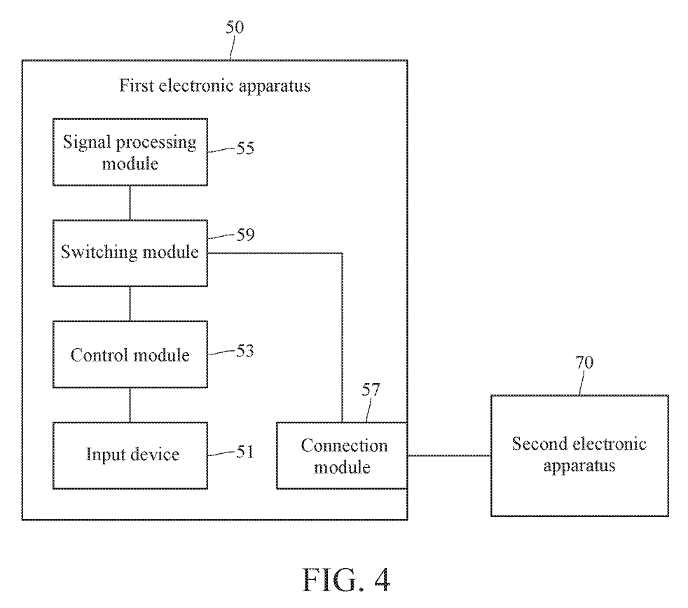

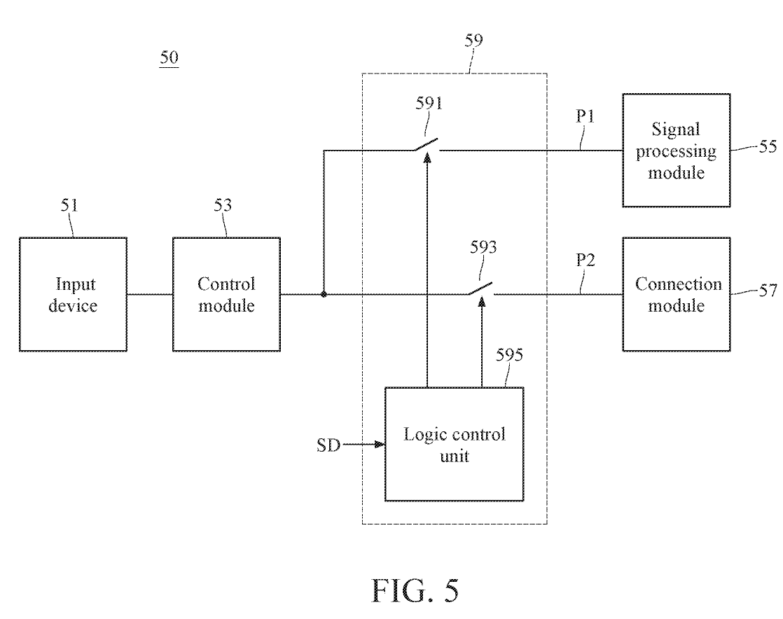

Please refer to FIG. 4 and FIG. 5. FIG. 4 is a functional block diagram of a first electronic apparatus and a second electronic apparatus in another embodiment, and FIG. 5 is a schematic diagram of a first transmission path and a second transmission path in an embodiment. A first electronic apparatus 50 is electrically connected to a second electronic apparatus 70 through a connection module 57 selectively. An input device 51, a control module 53, a signal processing module 55, the connection module 57 in the first electronic apparatus 50 are substantially the same as the relative components in FIG. 1. Different from the first electronic apparatus 10 in FIG. 1, the first electronic apparatus 50 further includes a switching module 59. The switching module 59 is electrically connected to the control module 53, and the switching module 59 selects to enable either a first transmission path P1 or a second transmission path P2 according to an assignment signal SD.

In practice, the switching module 59 includes a first switch 591, a second switch 593 and a logic control unit 595. The first switch 591 is disposed on the first transmission path P1, the second switch 593 is disposed on the second transmission path P2, and the logic control unit 595 controls the first switch 591 and the second switch 593 to enable either the first transmission path P1 or the second transmission path P2 according to the assignment signal SD. Therefore, the control module 53 can send the control signal to either the signal processing module 55 or the connection module 57, and either the signal processing module 55 or the connection module 57 then executes an input operation corresponding to the control signal.

In an embodiment, the assignment signal SD is generated by a selecting module in the first electronic apparatus 50. For example, a user can use keys on the outer surface of the first electronic apparatus 50 to select to assign the usage right of the input device 51 in the first electronic apparatus 50 to either the first electronic apparatus 50 or the second electronic apparatus 70. If the user uses the selecting module in the first electronic apparatus 50 to select to share the input device 51 in the first electronic apparatus 50 with the second electronic apparatus 70, the selecting module will generate an assignment signal SD according to the user's selection. Then, the switching module 59, according to the assignment signal SD, sends the control signal generated by the input device 51 to the connection module 57 through the second transmission path P2, and the connection module 17 transfers the control signal to the second electronic apparatus 70. Accordingly, the second electronic apparatus 70 can execute an input operation corresponding to this control signal. If the user does not use the selecting module in the first electronic apparatus 50 to select to share the input device 51 in the first electronic apparatus 50 with the second electronic apparatus 70, the switching module 59 will send the control signal generated by the input device 51 to the signal processing module 55 through the first transmission path P1 according to the assignment signal SD. Accordingly, the signal processing module 55 executes the input operation corresponding to this control signal.

In another embodiment, the assignment signal SD is not generated by the selecting module in the first electronic apparatus 50 but is generated when the second electronic apparatus 70 is electrically connected to the first electronic apparatus 50. When the switching module 59 in the first electronic apparatus 50 receives the assignment signal SD generated by the second electronic apparatus 70, the switching module 59 in the first electronic apparatus 50 will learn that the assignment signal SD indicates that the input device 51 should be shared with the second electronic apparatus 70, and then will enable the second transmission path P2. When the switching module 59 in the first electronic apparatus 50 has not received any assignment signal SD from the second electronic apparatus 70, the switching module 59 in the first electronic apparatus 50 will predetermine not to share the input device 51 with the second electronic apparatus 70 and then will enable the first transmission path P1. In this embodiment, when the switching module 59 enables the first transmission path P1, the control signal will be sent to the signal processing module 55; and when the switching module 59 enables the second transmission path P2, the control signal will be sent from the connection module 57 to the second electronic apparatus 70.

Other embodiments may be contemplated in which the assignment signal SD is generated by an executed app, as described with respect to FIG. 3. This will not be repeated hereinafter.

As set forth above, the disclosure provides an electronic apparatus with a sharable input device and an input device sharing method thereof, where the control module in the first electronic apparatus, according to the assignment signal, determines whether to share the input device with the second electronic apparatus, so as to select to either execute a relative input operation through the first transmission path or send the control signal to the second electronic apparatus through the second transmission path. In an embodiment, the assignment signal is generated by hardware, for example, the selecting module in the first electronic apparatus or the second electronic apparatus; in another embodiment, the assignment signal is generated by software, for example, an app executed by the first electronic apparatus, to determine whether to share the input device with the second electronic apparatus. In this way, a keyboard, a touch panel or another add-in input device of a notebook can be shared with a smart phone, whereby this smart phone executes an input operation. Therefore, the disclosure may diminish inconveniences in the compilation of documents and the input of information on a smart phone.

What is claimed is:

1. An input device sharing method applied to a first electronic apparatus for selectively and electrically connected to a second electronic apparatus, the input device sharing method comprising:
at least one input device of the first electronic apparatus generating a control signal according to an input information;
according to an assignment signal, determining whether to share the at least one input device with the second electronic apparatus; and
selectively outputting the control signal through either a first transmission path or a second transmission path according to determination result,
wherein when a signal processing module of the first electronic apparatus receives the control signal through the first transmission path, the signal processing module performs an input operation according to the control signal; and the second electronic apparatus receives the control signal through the second transmission path.

2. The input device sharing method according to claim 1, wherein the assignment signal is generated by a selecting module in the first electronic apparatus.

3. The input device sharing method according to claim 1, wherein the second electronic apparatus generates the assignment signal for the first electronic apparatus when being electrically connected to the first electronic apparatus.

4. The input device sharing method according to claim 1, further comprising:
executing an app which determines whether the second electronic apparatus proposes a request for sharing the input device, and generates the assignment signal when the request for sharing the input device is proposed from the second electronic apparatus.

5. The input device sharing method according to claim 1, wherein the input information is related to an action executed on the at least one input device.

6. An electronic apparatus comprising:
at least one input device for generating a control signal according to an input information;
a control module electrically connected to the at least one input device and configured to determine whether to share the at least one input device with an external electronic apparatus according to an assignment signal, and selectively output the control signal through either a first transmission path or a second transmission path according to determination result;
a signal processing module electrically connected to the control module through the first transmission path and configured to perform an input operation according to the control signal when receiving the control signal from the first transmission path; and
a connection module electrically connected to the control module through the second transmission path and selectively electrically connected to the external electronic apparatus, and the connection module configured to transmit the control signal to the external electronic apparatus when receiving the control signal through the second transmission path.

7. The electronic apparatus according to claim 6, further comprising:
a selecting module configured to generate the assignment signal.

8. The electronic apparatus according to claim 6, wherein the control module receives the assignment signal when the external electronic apparatus is electrically connected to the electronic apparatus.

9. The electronic apparatus according to claim 6, wherein the control module executes an app which determines whether the external electronic apparatus proposes a request for sharing the input device, and generates the assignment signal when the request for sharing the input device is proposed from the external electronic apparatus.

10. The electronic apparatus according to claim 6, further comprising a switching module electrically connected to the control module which selectively enables either the first transmission path or the second transmission path according to the assignment signal.
